(19) United States
(12) Patent Application Publication
(10) Pub. No.: US 2015/0012562 A1
(43) Pub. Date: Jan. 8, 2015

(54) Literary Recommendation Engine

(71) Applicant: Zola Books Inc., New York, NY (US)

(72) Inventors: Patrick Hu, New York, NY (US); Ardeshir Khazaei, New York, NY (US); Christopher Sim, New York, NY (US); Karen Ye Sun, New York, NY (US)

(73) Assignee: Zola Books Inc., New York, NY (US)

(21) Appl. No.: 14/172,677

(22) Filed: Feb. 4, 2014

Related U.S. Application Data
(60) Provisional application No. 61/760,457, filed on Feb. 4, 2013.

(51) Int. Cl. G06F 17/30

(52) U.S. Cl. CPC G06F 17/30306; G06F 17/30312; G06F 17/30528
USPC 707/769

(57) ABSTRACT

A literary recommendation engine is used to receive an object of interest to a user and make a recommendation based on the received object. For example, a user may provide a name of a book or author and receive a list of recommendations that a services determines to be responsive to the user's interests based on a profile for the “seed” book (or author) and/or the user profile.

### TECHNICAL FIELD

This document relates to a content recommendation engine.

### BACKGROUND

The Internet enables access to vast amounts of knowledge. However, navigating this vast knowledge can be problematic, which may result in user's receiving a less than positive experience.

### DESCRIPTION OF DRAWINGS

FIG. 1 is a user interface (UI) that presents a literary recommendation engine through a web browser.

FIG. 2 illustrates UI of an interface that allows a user to enter a book name in order to launch a recommendation engine that content related to the content shown above.

FIG. 3 illustrates a UI with a list of four results that have been retrieved that are responsive to the title that has been selected “Absolute Monarchs.”

FIG. 4 illustrates a UI with a description of the factors that are used by the literary recommendation engine.

FIG. 5 illustrates a UI with a control that allows users to add additional content with the control that allows a user to ADD ANOTHER book to the list of recommendations.

FIG. 6 illustrates a UI with a control that allows users to surface literary recommendation engine content into a social network (e.g., Facebook or Twitter).

FIG. 7 illustrates a UI with a transaction interface that allows a user to rate, preview, purchase or disfavor specified content.

FIG. 8 illustrates a UI that illustrates how two books are used as the basis for the list of recommendations shown.

FIG. 9 illustrates a client server architecture that may be employed to provide literary recommendations to a user community.

### DETAILED DESCRIPTION

Modern electronics enable access to rich libraries of content across a variety of devices. This content may include electronic books (“e-books”), periodicals, narrative web sites (e.g., blogs), rich media content (written content with embedded movies and/or audio, and electronic books. Publishers of these rich libraries are better able to monetize these libraries if the publishers are able to find content that is most responsive to a user's interest. However, navigating these libraries can be cumbersome and awkward and results in a less than positive experience if a user is forced to navigate less-than-interesting content while content more responsive to a user's interest is not surfaced. Therefore, a literary recommendation engine is configured to provide recommended content to a community of users.

A variety of stimuli exist that can be used to develop rich mathematical and analytical models in order to find the “best” content for a user. The “best” content may be identified as the content deemed most likely to be responsive to a user's interests. One stimuli that is available is includes a publishers catalog that is published with various records that describe the book and various attributes. For example, a publisher may distribute a record with a book title, ISBN number, author name, author bibliography, year of publishing, relationship to other works, and other labels that describe the book (e.g., genre, subgenre, mood, and special status indicators such as appearance on a specified bestseller list, indication one or more awards, and/or inclusion of a celebrity's “book of the month” list). A second stimulus may include a service that collects reader reviews and ratings. The reader reviews and ratings may be made available by a ratings service, a book publisher, and online retailer, and/or an online critic service.

Still other stimuli may be used. One other stimulus may include a very specialized service that semantically breaks down the plot of a book. For example, a content publisher may parse a book with an analytic engine that develops a mathematical model for the structure of the plot and the relationship between characters. The content publisher may supplement and/or verify the mathematic model for the plot structure of the plot with review by a human editor that adjusts the model developed by the computer. The parsing also may involve a categorization of the reading level, the historic timeframe (if applicable), dialect, character interaction, issues, themes, mood, and other labels that may assist in characterizing content.

With the availability of rich stimuli and data available to describe literary content, a recommendation engine may assimilate these diverse stimuli in a reconciliation process that aims to de-duplicate records. While in some cases the ISBN number may be used as a common index, in other cases, an ISBN number may not be accurate or be available. For example, a review engine may “crawl” the web for trends in literature. A tweet or comment on a blog may not be indexed with a precise label identifier. Thus, the supplemental content may undergo a degree of parsing to identify the underlying source content and confirm that the review in fact relates to the identified source content. A quote in a blog that features a name of a character in a novel and/or a book title may be analyzed to identify other content appearing in the web page to confirm that the excerpt specifically relates to a particular piece of content.

Once the content is assimilated into a database (distributed in multiple locations or consolidated into a single data store), the literary recommendation engine may be configured to support a user community. The user community may allow users to create online profiles that in turn are managed by the literary recommendation engine. The literary recommendation engine may monitor user navigation activities within the literary recommendation engine to develop a user and community profile of how users are finding their content. The literary recommendation may be configured to develop inferences so that as a user interacts with the literary recommendation engine, the literary recommendation engine identifies affinities between content for which a relationship may be identified. Thus, as a user selects a recommendation link and/or purchases the recommended content, the relationship metrics are modified to reflect that association.

In one configuration, the user submits the name of a “seed” book in order identify related content. In response to receiving the name of the seed book, the literary recommendation engine may pull up a literary data object for the book that includes metadata for the book. The metadata may include descriptions of related content. In one configuration, the metadata includes a complex mathematical model that describes the relationship between the book (or an author or genre) and other data objects (e.g., books or authors or genres or characters or plot elements or themes). The user profile then may be used in association with the literary data object to identify an affinity between the user profile and other literary data objects. For example, a particular seed book may involve a detective in the Soviet Union (e.g., Gorky Park by Martin Cruz Smith). A literary data object may identify include values that relate Gorky Park to novels by other authors (e.g., detective novels by Fredrikh Topol) in addition to other detective novels (e.g., Sherlock Holmes). The literary recommendation engine may identify the top 25 values with the largest magnitude from a subset of a much larger library of values. These top 25 values then may in turn be mapped on a multidimensional axis against a user profile to identify those selections with a strong magnitude that also aligns with the user's interest as expressed in the user's profile. The literary recommendation engine then may in turn identify the top X selections where X is a limit set to filter the content presented to the user.

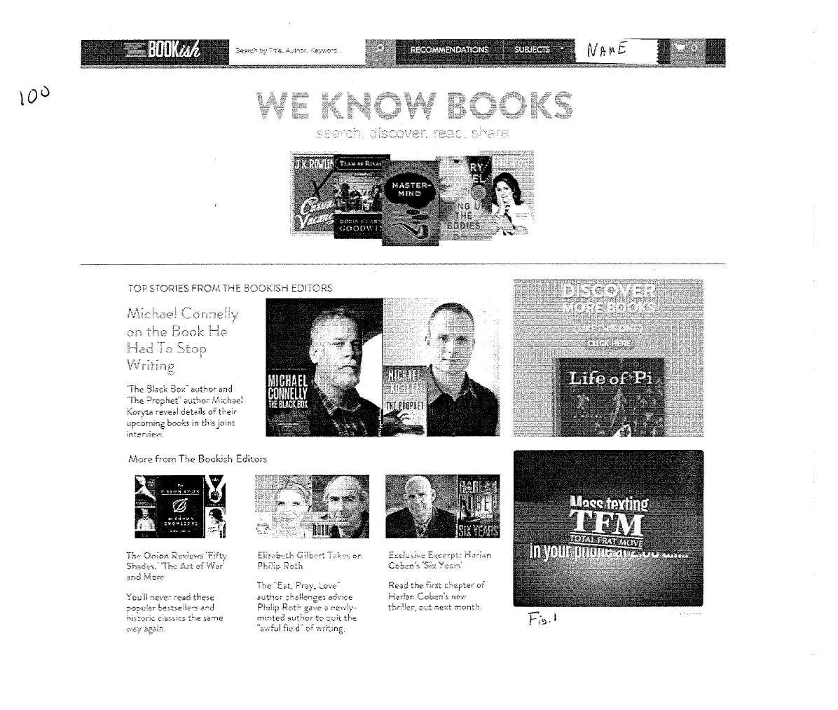

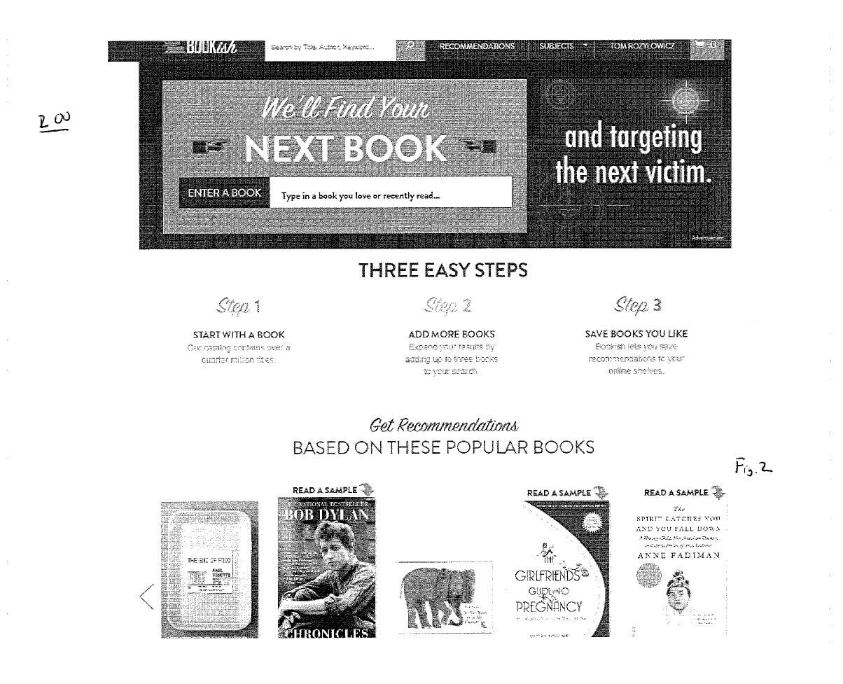

FIGS. 1-8 are screenshots of a literary recommendation engine that is configured to provide literary recommendation services to a user community. FIG. 1 is a user interface (UI) 100 that presents a literary recommendation engine through a web browser. As shown, the user with the specified profile NAME (e.g., John A. Smith) is presented with the ability to perform a search, perceive a list of recommendations, search by subject purchase books (as shown throw a shopping cart), browse the top stories by editors, or engage in a discovery process whereby the user can express their likes and dislikes in order to hone preferences and better identify more responsive content. As the user types in characters into the search entry field, a drop down window (not shown) may be presented that enables the user to perceive the content that aligns with the entered text).

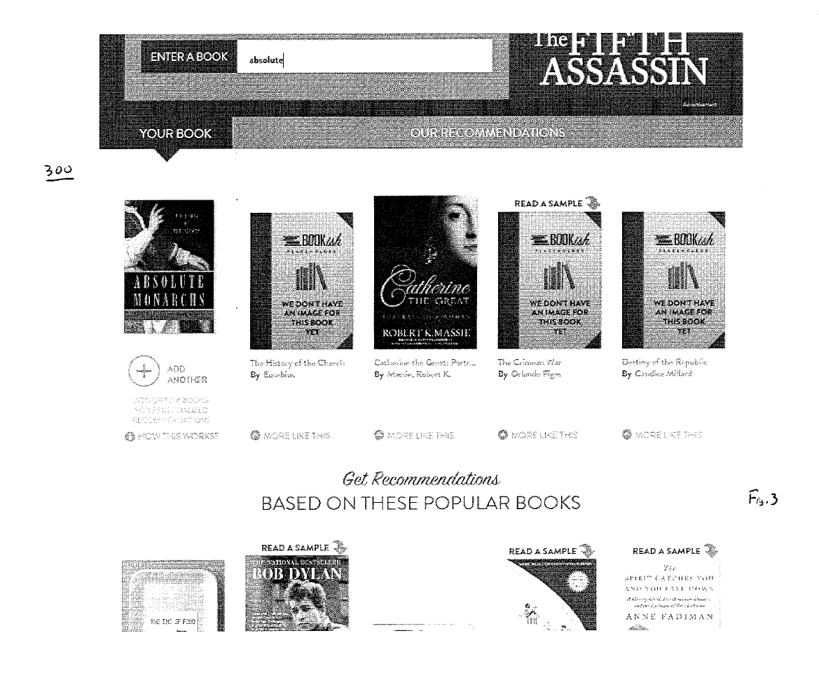

FIG. 2 illustrates UI 200 of an interface that allows a user to enter a book name in order to launch a recommendation engine that content related to the content shown above. As shown, the user is permitted to enter up to three titles in order to generate responsive content. The user also may save links to the content that has been presented in order to allow the user to perceive the retrieved content at a later time.

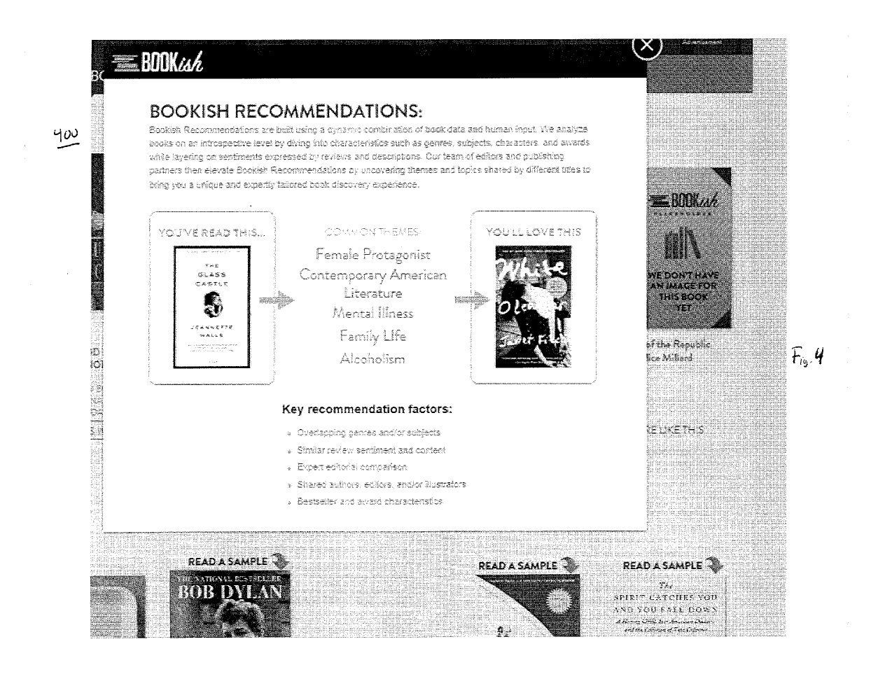

FIG. 3 illustrates a UI 300 with a list of four results that have been retrieved that are responsive to the title that has been selected “Absolute Monarchs.” The user may interface with the retrieved links, for example, by selecting the “MORE LIKE THIS” link shown below the title. Selecting the MORE LIKE THIS link may be used to include the selected title as modifying criteria so that the newly employed model also reflects aspects of the newly-selected content.

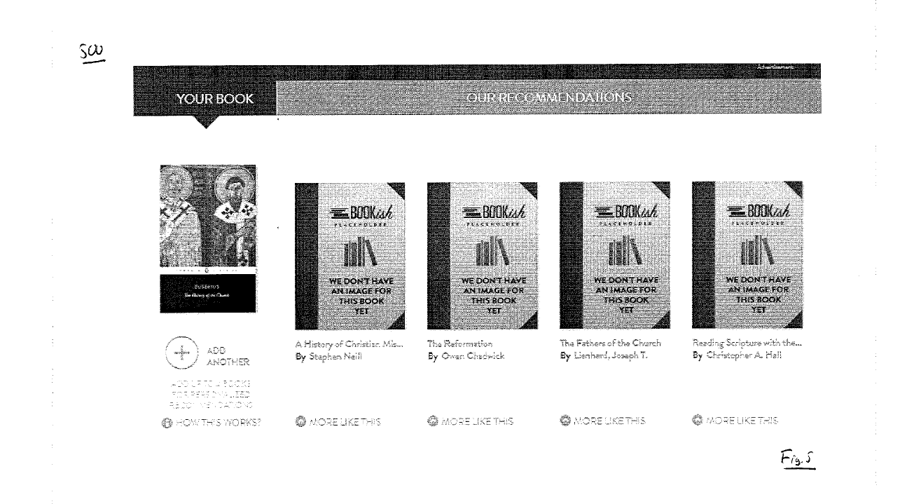

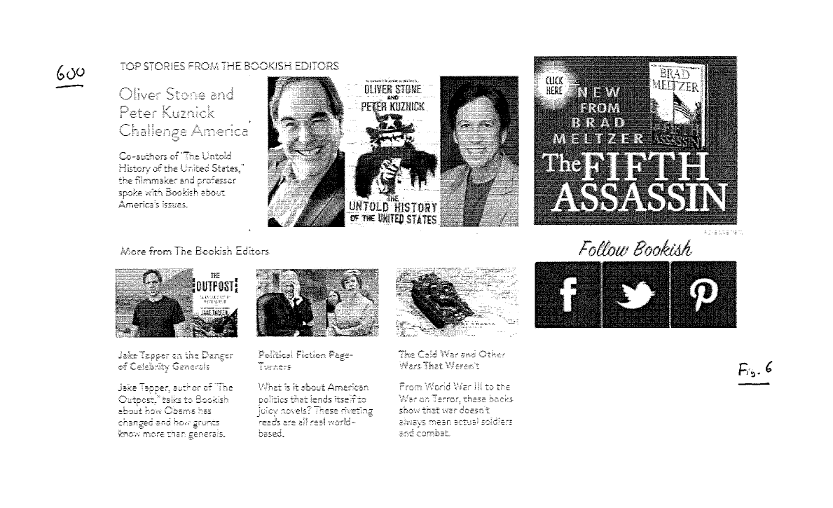

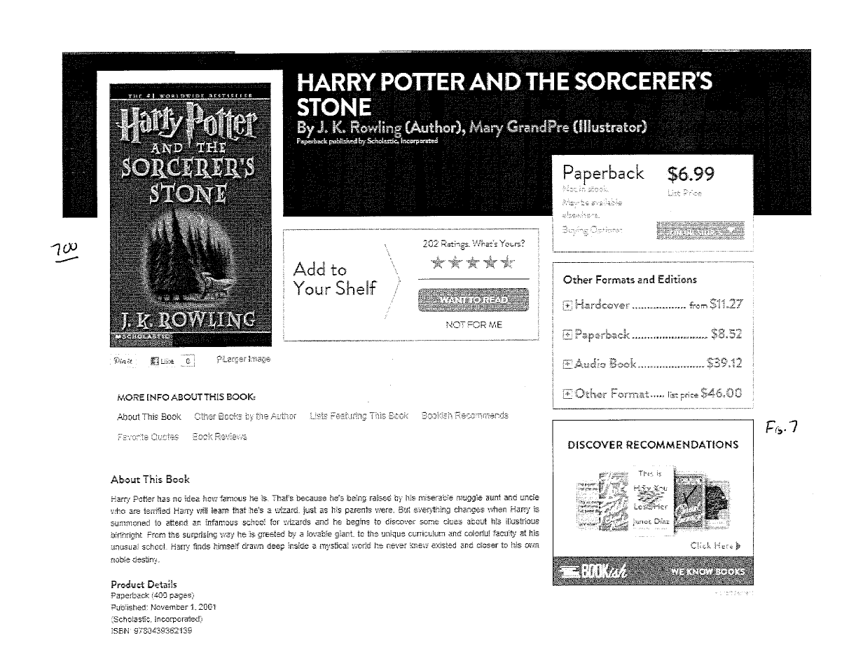

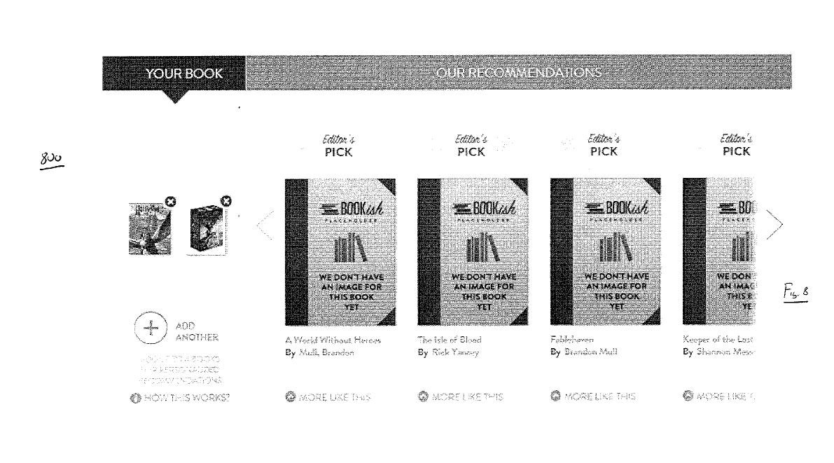

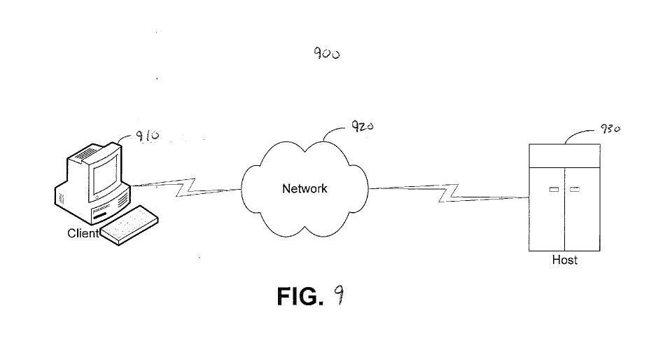

FIG. 4 illustrates a UI 400 with a description of the factors that are used by the literary recommendation engine. Each of these aspects may represent one axis of a multidimensional axis as content is related to user requests, user profiles, and seed content. Of course, the analysis performed by the literary recommendation engine also may be modified to reflect current trends and popularity. Thus, a smaller value for results that include vampire-themed content may nevertheless allow vampire-themed results to be returned if vampire-themed content is popular. However, if the user actively navigates away from vampire-themed content, the impact of the popularity of vampire-themed content may be diminished so that vampire-themed content is not as likely to be returned in a list of recommendations.

FIG. 5 illustrates a UI 500 with a control that allows users to add additional content with the control that allows a user to ADD ANOTHER book to the list of recommendations. In addition, the list of recommendations also allows each recommendation to be explored by selecting the book icon for each result.

FIG. 6 illustrates a UI 600 with a control that allows users to surface literary recommendation engine content into a social network (e.g., Facebook or Twitter). Similarly, the social networking controls may allow information from the user's social network to modify the results of the literary recommendation engine.

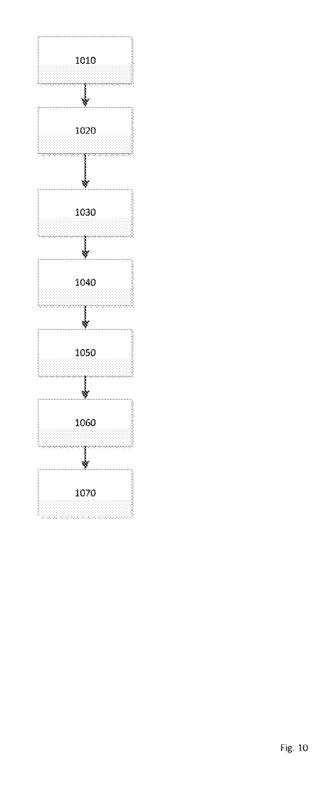

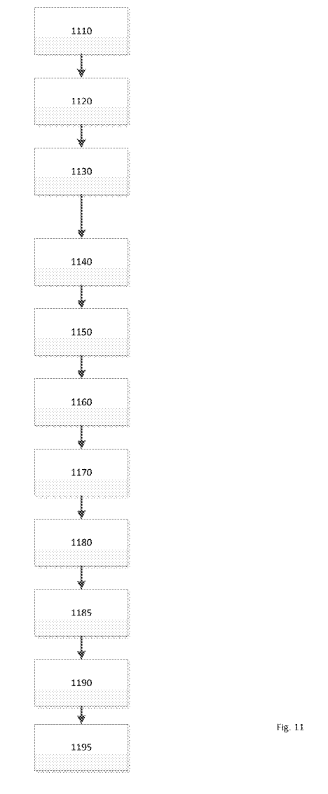

FIG. 7 illustrates a UI 700 with a transaction interface that allows a user to rate, preview, purchase or disfavor specified content. The user also may specify delivery options for purchased content. FIG. 8 illustrates a UI 800 that illustrates how two books are used as the basis for the list of recommendations shown. In one configuration, a common model with aspects of both books is developed to identify responsive content. In another configuration, a mathematical model of the books and their characters are developed and merged. Common aspects of the mathematical model then may be related to the user profile while aspects of the books that are not common to both books may be excluded from the analysis.

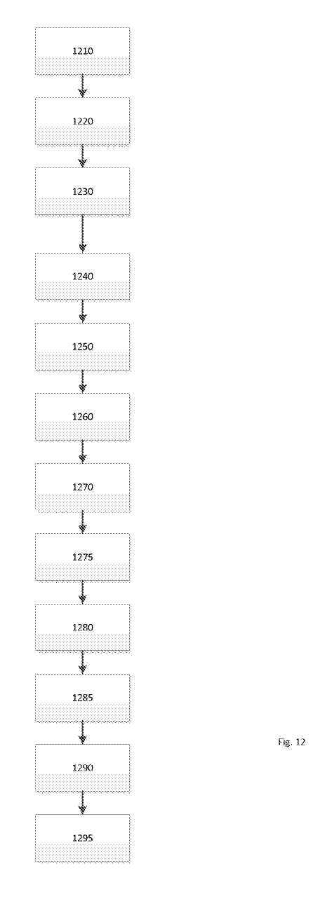

FIG. 9 illustrates a client server architecture that may be employed to provide literary recommendations to a user community. More precisely, FIG. 9 is a block diagram of a communications system 900 configured enabling a client 910 to access a host 930 across a network 920 in order to receive services from a literary recommendation engine operated by a host. . Generally, the client 910 is configured to access content on the host 930.

The client 910 may include one or more external interfaces from which the portable media device receives content. Typically, the external interface is used to receive electronic content and also software (e.g., firmware) that controls the operation of the portable media device. Examples of the external interface may include, but are not limited to, Universal Serial Bus (USB) and/or FireWire connections, wireless LAN interfaces (e.g., 802.11 (a), (b), (g), or (n)), Personal Area Network connections (e.g., infrared or Bluetooth TM), Wide Area Network connections, wireless phone connections, and/or proprietary interfaces. The external interface may be configured to exchange data with a client 910, host 930, and/or other portable media devices (not shown).

The client 910 typically includes a computing device enabling a user to exchange information over a communications network. The client 910 may include one or more devices capable of accessing content residing on client 910 and/or host 930. The client 910 may include a controller (not shown) that processes instructions received from or generated by a software application, a program, a piece of code, a device, a computer, a computer system, or a combination thereof, which independently or collectively direct operations of the client 910. The instructions may be embodied permanently or temporarily in any type of machine, component, equipment, storage medium, or propagated signal that is capable of being delivered to the client 910 or that may reside with the controller at client 910. Client 910 may include a general-purpose computer (e.g., a personal computer (PC)) capable of responding to and executing instructions in a defined manner, a workstation, a notebook computer, a PDA (“Personal Digital Assistant”), a wireless phone, a component, other equipment, or some combination of these items that is capable of responding to and executing instructions.

In one implementation, the client 910 includes one or more information retrieval software applications (e.g., a browser, a mail application, an instant messaging client, an Internet service provider client, or an AOL TV or other integrated client) capable of receiving one or more data units. The information retrieval applications may run on a general-purpose operating system and a hardware platform that includes a general-purpose processor and specialized hardware for graphics, communications and/or other capabilities. In another implementation, client 910 may include a wireless telephone running a micro-browser application on a reduced operating system with general purpose and specialized hardware capable of operating in mobile environments.

The client 910 may include one or more media or e-book reading applications. For example, the client 910 may include a software application that enables the client 910 to receive and display an e-book presented in a specified book format. The media applications may include controls that enable a user to configure the user's media environment. For example, if the e-book application is accessing an online bookstore or recommendation engine (such as those shown in FIGS. 1-8), the media application may include controls that enable the user to select and purchase electronic books, for example, through the use of a recommendation engine and/or a web browsing application.

The client 910 may include an inspection engine that regulates use of the different communications interfaces which may be available. For example, the client 910 may be configured to route all communications requests through the inspection engine. The inspection engine may reference a communications configuration and selectively enable access to a communications network based on the nature of the communications request and the communications configuration. The inspection engine and e-book application may be used in an “armored” or trusted mode so that a communications interface and the underlying content may not be accessed without authorization.

In one implementation, the different applications requiring use of a communications interface are required to register with the compliance engine. Registering with the compliance engine may permit a registered application to access valuable, copyrighted content. For example, a registered application may treat the compliance engine as an internal communications module used to exchange data. The inspection module then may selectively enable access to content based on rules in the communications and permissions configuration.

In another implementation, the compliance engine internally announces itself as the communications interface. Applications need not register with the compliance engine in order to communicate. However, the compliance engine may only establish access to and communications in support of those communications described and authorized in the compliance file.

The network 920 typically includes hardware and/or software capable of enabling direct or indirect communications between the client 910 and the host 930. As such, the network 920 may include a direct link between the client 910 and the host 930, or it may include one or more networks or subnetworks between them (not shown). Each network or subnetwork may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

The host 930 generally includes one or more devices configured to distribute digital content. For example, the host 930 may offer a literary recommendation engine that allows users to navigate literary libraries. Typically, a host 930 includes a collection or library of content for distribution. Alternatively, or in addition, the host 930 may enable access to other forms of rich media content (or convert a media source such as a video or audio feed) into a feed of data units for transmission across the network 920. The host 930 may include a general-purpose computer having a central processor unit (CPU), and memory/storage devices that store data and various programs such as an operating system and one or more application programs. Other examples of a host 930 includes a workstation, a server, a special purpose device or component, a broadcast system, other equipment, or some combination thereof capable of responding to and executing instructions in a defined manner.

The host 930 also may include an input/output (I/O) device (e.g., video and audio input and conversion capability), and peripheral equipment such as a communications card or device (e.g., a modem or a network adapter) for exchanging data with the network 920.

The host 930 is generally capable of executing instructions under the command of a controller. The host 930 may be used to provide content to the client 910. The controller may be implemented by a software application loaded on the host 930 for commanding and directing communications exchanged with the client 910. Other examples of the controller include a program, a piece of code, an instruction, a device, a computer, a computer system, or a combination thereof, for independently or collectively instructing the client 910 or the host 930 to interact and operate as described. The host 930 may be embodied permanently or temporarily in any type of machine, component, physical or virtual equipment, storage medium, or propagated signal capable of providing instructions to the client 910 or the host 930.

The host 930 may be configured to store content for the client 910. In one implementation, the host 930 represents a central repository that stores a user's content. The host 930 then may be configured to enable user access to the user's library regardless of whether the user is using or is in proximity to a user's client. In another implementation, the host 930 represents a robust content store. The host 930 may be configured to provide Internet radio streams, enable a user to purchase a content selection, and enable access to promotional content.

FIG. 10 is a flow chart of a process by which a database of literary content is developed. Generally the operations shown in FIG. 10 may be performed using the user interfaces and systems described previously.

Initially, a first description of a first literary object is received from a first data source (1010) and a second description of a second literary object is received from a second data source (1020). The first description of the literary object a mathematical or analytic label attached to a record in a database that facilitates processing and analytics in a manner that determines a mathematical or analytical relationship between an entry (object) in a database and other objects appearing in the database. Identifying similar aspects and/or the extent of a relationship between two objects may be masked where the underlying values reflect an analytical report or parsing of the underlying content. For example, two novels by a first author may have dramatically different relationship as early works focus on a pace of action and later works focus more on character development with less action. The descriptions may include a label for a pace of activity or a mathematical value representing the pace of activity. Thus, an operator looking at two different works by the same author or two different works in the same genre may not appreciate the similarities and differences between those works. While directly-read lead labels also may be employed to identify relationships, descriptions need not be limited to directly-read information.

The first description of the first literary object is related to the second description of the second literary object (1030). For example, a server may determine the relationship between an early work by John Grisham and more recent work.

Based on relating the first description of the first literary object to the second description of the second literary object, a degree of correlation is determined (1040). A threshold used to determine whether two objects are related is accessed (1050). The threshold with the degree of correlation is compared (1060). Based on comparing the degree of correlation with the threshold, it is determined whether the first literary object and the second literary object are related (1070). The degree of correlation can be stored in a database for subsequent manipulation and access so that related content can readily be identified. The first literary object and the second literary object may be consolidated into a merged record that includes a first aspect of the first literary object and a second aspect of the second literary object. For example, a list of novels with a first pace of activity and a list of novels with a second tone may be joined to create a record that identifies content with a first pace of activity and a second tone. If a user later looks for content responsive to their profile, records of this sort may be used to readily identify content.

FIG. 11 illustrates a method of recommending a literary object to a user. Initially, a first literary object in a database of literary objects is identified (1110). A first literary object includes a record with descriptors that may be used to mathematically identify relationships (or the relative strength of relationships) between content. A first model for the first literary object is developed (1120). The first model may include a record in a database that describes the mathematical relationship between one or more selections of content. A first stream of content with a sequence of records that includes a first record is accessed (1130). relationship between the first record and the first literary object is identified (1140). A first aspect from the first record is identified (1150). The first literary object to reflect the first aspect is modified (1160). A user profile is accessed (1170). From within the user profile, interests across one or more dimensions is identified (1180). A subset of the interests with a stronger magnitude is identified (1185).

It is determined that the first literary object is responsive to the subset of interests with the stronger magnitude (1190). A description of the first literary object is presented to the user with the user profile (1195).

FIG. 12 illustrates a method of recommending a literary object to a user. Initially, a computer identifies a first literary object in a database of literary objects (1210). The computer develops a first model for the first literary object (1220). A first stream of content with a sequence of records that includes a first record is accessed using a computer (1230). A relationship between the first record and the first literary object is accessed using a computer (1240). A first aspect from the first record is identified (1250). The first literary object is modified to reflect the first aspect using a computer (1260). A user request for content that reflects a seed item is received (1270). A seed profile for a seed item with one or more dimensions is identified using a computer (1275). A subset of the interests with a stronger magnitude for the seed profile is identified (1280). A user request for the user is accessed using a computer (1285). The computer determines that the first literary object is responsive to the subset of interests with the stronger magnitude (1290). The computer presents a description of the first literary object to the user with the user profile in a list of literary objects (1295).

Other implementations are within the scope of the following claims. For example, although many of the operations were describes as being performed on a personal computer, the operations also may be performed on other devices, such as a wireless phone. In another implementation, a reconfigurable communications interface is dynamically configured based on the communications configuration that is accessed. For example, a wireless network interface may be configured to operate in different modes and/or bandwidths. Each mode may be associated with a difference performance capability, range, and/or cost. In one example, the communications configuration instructs the client to use a low bandwidth wireless packet mode to exchange instant messages in order to reduce costs while instructing the client to use a high bandwidth mode on the same wireless (and more expensive) for mission critical communications.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications to the specific examples described above also are contemplated.

What is claimed is:

1. A method of developing a database of literary content, the method comprising:
receiving, from a first data source, a first description of a first literary object;
receiving, from a second data source, a second description of a second literary object;
relating the first description of the first literary object to the second description of the second literary object;
determining, based on relating the first description of the first literary object to the second description of the second literary object, a degree of correlation;
accessing a threshold used to determine whether two objects are related;
comparing the threshold with the degree of correlation; and
determining, based on comparing the degree of correlation with the threshold, whether the first literary object and the second literary object are related.

2. The method of claim 1 further comprising:
consolidating the first literary object and the second literary object into a merged record that includes a first aspect of the first literary object and a second aspect of the second literary object.

3. A method of recommending a literary object to a user, the method comprising:
identifying a first literary object in a database of literary objects;
developing a first model for the first literary object;
accessing a first stream of content with a sequence of records that includes a first record;
identifying a relationship between the first record and the first literary object;
identifying a first aspect from the first record;
modifying the first literary object to reflect the first aspect;
accessing a user profile;
identifying, from within the user profile, interests across one or more dimensions;
identifying a subset of the interests with a stronger magnitude;
determining that the first literary object is responsive to the subset of interests with the stronger magnitude; and
presenting a description of the first literary object to the user with the user profile.

4. A method of recommending a literary object to a user, the method comprising:
identifying a first literary object in a database of literary objects;
developing a first model for the first literary object;
accessing a first stream of content with a sequence of records that includes a first record;
identifying a relationship between the first record and the first literary object;
identifying a first aspect from the first record;
modifying the first literary object to reflect the first aspect;
receiving a user request for content that reflects a seed item;
identifying, a seed profile for a seed item with one or more dimensions;
identifying a subset of the interests with a stronger magnitude for the seed profile;
accessing a user request for the user;
determining that the first literary object is responsive to the subset of interests with the stronger magnitude; and
presenting a description of the first literary object to the user with the user profile in a list of literary objects.
